(19) United States
(12) Patent Application Publication
(10) Pub. No.: US 2024/0158248 A1
(43) Pub. Date: May 16, 2024

(54) METHOD FOR RECOVERING AMMONIA

(71) Applicant: SEOUL NATIONAL UNIVERSITY R&DB FOUNDATION, Seoul (KR)

(72) Inventors: Yong Ju CHOI, Seoul (KR); Jae Beom PARK, Seoul (KR); Woo Ram LEE, Seoul (KR)

(21) Appl. No.: 18/487,574

(22) Filed: Oct. 16, 2023

(30) Foreign Application Priority Data
Nov. 14, 2022 (KR) 10-2022-0151438

(51) Int. Cl. C01C 1/242; B01D 9/00; B01D 19/00; B01D 69/02

(52) U.S. Cl. CPC C01C 1/242; B01D 9/0054; B01D 19/0031; B01D 69/02; B01D 2009/0086; B01D 2325/02832; B01D 2325/02833; B01D 2325/02834; B01D 2325/04; B01D 2325/38; C01P 2002/72; C01P 2002/82

(57) ABSTRACT

The present disclosure relates to a method for recovering ammonia, the method comprising (a) preparing a gas containing ammonia,(b) supplying the gas containing ammonia to a mixed solution of an aqueous solution of sulfuric acid and a antisolvent of ammonium sulfate, to obtain ammonium sulfate crystals, and (c) separating the ammonium sulfate crystals from the mixed solution, wherein a volume ratio of the antisolvent of ammonium sulfate to the aqueous solution of sulfuric acid is greater than 1.

### CROSS-REFERENCE TO RELATED APPLICATION

This application claims the benefit of Korean Application No. 10-2022-0151438, filed Nov. 14, 2022, which is hereby incorporated by reference in their entirety.

### 1. FIELD

The present disclosure relates to a method for recovering ammonia.

### 2. BACKGROUND

Ammonia is widely used in various fields including agricultural fertilizers and chemical industrial materials, and is produced in such a large amount that 1% of the world's fossil fuel energy and 50% of industrially produced hydrogen are used for ammonia production. Ammonia produced in this way flows into sewage treatment plants after use and becomes a major cause of water pollution, and the amount discharged in this way amounts to 19% of the total ammonia production.

In order to recover ammonia from wastewater, ammonia separation and recovery technologies such as ammonia degassing towers, ammonia membrane contactors, and ammonia adsorption towers have been developed, but most of them involve recovering ammonia in the form of dissolved ammonia as ammonium ions in acidic absorption solutions such as dilute sulfuric acid, for example in the form of an aqueous solution of ammonium sulfate. Ammonia recovered in the form of a solution is not only difficult to transport, but also has a problem in that it cannot be immediately reused in the industry due to its low usability and concentration. However, the evaporation method and the membrane method, which are conventional methods of crystallizing dissolved ammonium sulfate, have problems in that a large amount of energy is consumed or a long time is required in the evaporation or membrane separation process.

Therefore, in order to improve the usability of the ammonia recovery process, it is necessary to develop a method for efficiently crystallizing ammonium sulfate during ammonia recovery.

### SUMMARY

One of the various purposes of the present disclosure is to provide a method for recovering ammonia, capable of efficiently obtaining high-quality ammonium sulfate crystals.

According to one aspect of the present disclosure, a method for recovering is provided, the method including (a) preparing a gas containing ammonia; (b) supplying the gas containing ammonia to a mixed solution of an aqueous solution of sulfuric acid and a antisolvent of ammonium sulfate, to obtain ammonium sulfate crystals; and (c) separating the ammonium sulfate crystals from the mixed solution, wherein a volume ratio of the antisolvent of ammonium sulfate to the aqueous solution of sulfuric acid is greater than 1.

According to an embodiment, the volume ratio of the antisolvent of ammonium sulfate to the aqueous solution of sulfuric acid may be 1.5 or more.

According to an embodiment, the volume ratio of the antisolvent of ammonium sulfate to the aqueous solution of sulfuric acid may be 3 or more.

According to an embodiment, the antisolvent of ammonium sulfate may be selected from a group consisting of methanol, ethanol, 1,4-dioxane, dimethylformamide and acetone.

According to an embodiment, temperature of the mixed solution at step (b) may be 10˜30° C.

According to an embodiment, the separating at step (c) may be performed through filtering.

According to an embodiment, the preparing of a gas containing ammonia may be performed by a hydrophobic gas permeable membrane and a liquid-gas separation membrane contactor including a first region and a second region separated by the hydrophobic gas permeable membrane.

According to an embodiment, step (a) may include (al) supplying treated water including ammonia to the first region and supplying an ammonia nonreactive gas to the second region; and (a2) recovering the gas containing ammonia from the second region.

According to an embodiment, flow direction of the treated water of the first region and flow direction of the ammonia nonreactive gas of the second region may be opposite to each other.

According to an embodiment, a pore of the hydrophobic gas permeable membrane may not transmit liquid phase matter.

According to an embodiment, the hydrophobic gas permeable membrane may satisfy at least one of conditions (i) to (iv) below:
(i) thickness of 10˜2001.tm;
(ii) average pore size of 0.01˜0.50 μm;
(iii) porosity of 30˜85%; and
(iv) hydrophobic substance.

According to an embodiment, the treated water including ammonia may be sewage, and the sewage may satisfy at least one of the conditions (1) to (5) below:
(1) pH 6.0˜8.0;
(2) nitrogen content is 25˜50mg/L;
(3) calcium carbonate alkali is 100˜300mg/L;
(4) dissolved organic matter content is 5˜15mg/L; and
(5) suspended matter content is 10˜50mg/L.

As one of the various effects of the present disclosure, high-quality ammonium sulfate crystals can be efficiently obtained by supplying gaseous ammonia to a mixed solution of an aqueous solution of sulfuric acid and a antisolvent of ammonium sulfate.

The effects of the present disclosure are not limited to the above effects, and should be understood to include all effects that can be inferred from the description of the invention or the configuration described in the claims of this specification.

### BRIEF DESCRIPTION OF THE DRAWINGS

FIG. 1 is a schematic concept view of a liquid-gas separation membrane contactor used in an ammonia-containing gas preparation step according to a method for recovering ammonia according to an embodiment of the present disclosure;

FIG. 2 is a graph showing a crystallization efficiency of ammonium sulfate according to a volume ratio of a antisolvent of ammonium sulfate to an aqueous sulfuric acid solution;

FIG. 3A is a result of XRD analysis of ammonium sulfate crystals obtained by the conventional evaporation crystallization method, and FIG. 3B is a result of XRD analysis of ammonium sulfate crystals obtained by a antisolvent crystallization method of the present disclosure;

FIG. 4A is a schematic concept view for explaining a method for recovering ammonia according to an embodiment of the present disclosure, and FIG. 4B is an image of an actual module for performing a method for recovering ammonia according to an embodiment of the present disclosure; and

FIG. 5 is an FT-IR analysis result of ammonium sulfate according to an embodiment of the present disclosure.

### DETAILED DESCRIPTION

Hereinbelow, one aspect of the present specification will be described. However, the descriptions in this specification may be implemented in many different forms, and thus are not limited to the embodiments described herein. In addition, in order to clearly explain one aspect of the present specification, parts irrelevant to the description are omitted.

Throughout the specification, when it is stated that a part is “connected” to another part, this includes not only the case of being “directly connected” but also the case of being “indirectly connected” with another member in between. In addition, when a certain component is said to “include”, this means that it may further include other components, not excluding other components unless otherwise specified.

When ranges of numerical values are set forth in the present specification, unless the specific range is stated otherwise, the values have the precision of significant digits provided in accordance with the standard rules in chemistry for significant digits. For example, 10 includes the range 5.0 to 14.9, and the number 10.0 includes the range 9.50 to 10.49.

Hereinafter, an embodiment of the present specification will be described in detail with reference to the accompanying drawings.

### Method for Recovering Ammonia

A method for recovering ammonia according to one aspect of the present disclosure includes (a) preparing a gas containing ammonia, (b) supplying the gas containing ammonia to a mixed solution of an aqueous solution of sulfuric acid and a antisolvent of ammonium sulfate, thereby obtaining ammonium sulfate crystals, and (c) separating the ammonium sulfate crystals from the mixed solution.

Hereinbelow, each of (a) to (c) will be described in detail.

### (a) Preparing a Gas Containing Ammonia

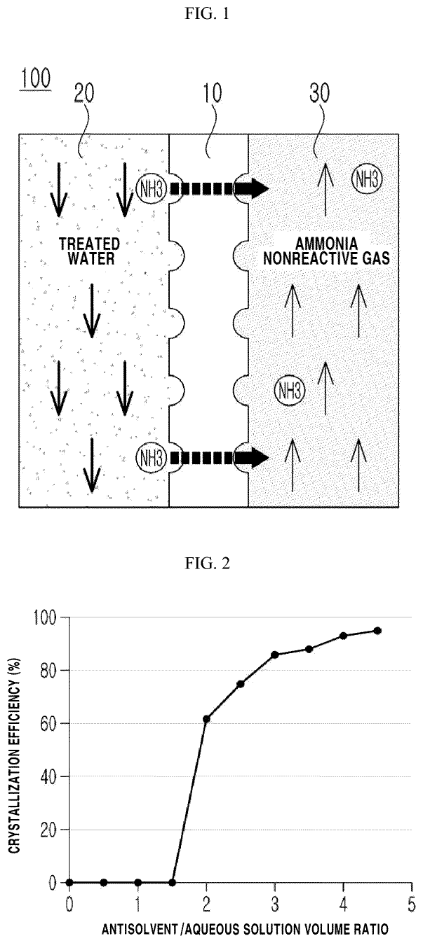

In the present disclosure, there is no particular limitation to the step of preparing a gas containing ammonia, but for example, as illustrated in FIG. 1, the preparing of a gas containing ammonia may be performed by a hydrophobic gas permeable membrane 10, and a liquid-gas separation membrane contactor 100 including a first region 20 and a second region 30 divided on the basis of the hydrophobic gas permeable membrane 10.

According to an embodiment, step (a) may consist of (a1) supplying treated water containing ammonia to the first region 20 and supplying an ammonia nonreactive gas to the second region 30, and (a2) recovering the gas containing ammonia from the second region 30. In this case, at an interface between the hydrophobic gas permeable membrane 10 and the second region 30, ammonia can be recovered without direct contact with a solvent or antisolvent, thereby inhibiting the membrane from deteriorating its lifespan due to membrane wetting.

The hydrophobic gas permeable membrane 10 may serve as a passage through which the ammonia included in the treated water supplied to the first region 20 moves to the second region 30. This movement of the ammonia may be due to a difference in partial pressure between the first region 20 and the second region 30. Dissolved ammonia in the treated water of the first region 20 may evaporate into a gas phase at an interface between the treated water and membrane pores according to a gas phase-aqueous liquid phase equilibrium relationship, and diffuse to an ammonia non-reactive gas side of the second region 30. Meanwhile, as the gas containing ammonia is recovered at step (a2), the partial pressure difference between the first region 20 and the second region 30 may be continuously maintained, and as a result, selective diffusion where the ammonia gas continuously movies from the first region 20 to the second region 30 may be induced.

According to an example, flow direction of the treated water of the first region 20 and flow direction of the ammonia non-reactive gas of the second region 30 may be opposite to each other. When the flow directions of the treated water of the first region 20 and the gas of the second region 30 are opposite to each other as described above, it is possible to form a difference in partial pressure of the ammonia gas between the treated water and the gas throughout an entire region from one end to the other end of the hydrophobic gas permeable membrane 10, thereby improving the ammonia recovery efficiency.

The ammonia nonreactive gas may be air, nitrogen (N₂), oxygen (O₂), helium (He) or Argon (Ar), but there is no limitation thereto as long as it is a gas that is nonreactive with ammonia.

According to an example, pores of the hydrophobic gas permeable membrane 10 may not transmit a liquid phase matter. Otherwise, if the pores transmit the liquid phase matter, ions dissolved in the treated water will permeate, making it difficult for gas phase ammonia to move, which may reduce the recovery speed, and may cause wetting of the membrane, reducing the lifespan of the membrane.

According to an example, the hydrophobic gas permeable membrane may satisfy at least one of conditions (i) to (iv) below.
(i) Thickness of 10˜200 μm, for example, 10 μm, 15 μm, 20 μm, 25 μm, 30 μm, 35 μm, 40 μm, 45 μm, 50 μm, 55 μm, 60 μm, 65 μm, 70 μm, 75 μm, 80 μm, 85 μm, 90 μm, 95 μm, 100 μm, 105 μm, 110 μm, 115 μm, 120 μm, 125 μm, 130 μm, 135 μm, 140 μm, 145 μm, 150 μm, 155 μm, 160 μm, 165 μm, 170 μm, 175 μm, 180 μm, 185 μm, 190 μm, 195 μm, 200 μm, or a value between two values thereof;
(ii) Average pore size of 0.010.50 μm, for example, 0.01 μm, 0.05 μm, 0.10 μm, 0.15 μm, 0.20 μm, 0.25 μm, 0.30 μm, 0.35 μm, 0.40 μm, 0.45 μm, 0.50 μm, or a value between two values thereof;
(iii) Porosity of 3085%, for example, 30%, 35%, 40%, 45%, 50%, 55%, 60%, 65%, 70%, 75%, 80%, 85%, or a value between two values thereof; and
(iv) Hydrophobic substance.

According to an example, (iv) the hydrophobic substance may be Polypropylene (PP), Polyvinylidene fluoride (PVDF) or Polytetrafluroethylene (PTFE), but there is no limitation thereto.

According to an example, the treated water including ammonia may be sewage. Here, “sewage” may refer to the totality of things generated or incidental by life or business and including ammonia nitrogen, regardless of terms such as drainage, wastewater, etc.

According to an example, sewage may satisfy at least one of conditions (1) to (5) below:
(1) pH 6.08.0, for example, 6.0, 6.1, 6.2, 6.3, 6.4, 6.5, 6.6, 6.7, 6.8, 6.9, 7.0, 7.1, 7.2, 7.3, 7.4, 7.5, 7.6, 7.7, 7.8, 7.9, 8.0, or a value between two values thereof;
(2) Nitrogen content of 25˜50 mg/L, for example, 25 mg/L, 26 mg/L, 27 mg/L, 28 mg/L, 29 mg/L, 30 mg/L, 31 mg/L, 32 mg/L, 33 mg/L, 34 mg/L, 35 mg/L, 36 mg/L, 37 mg/L, 38 mg/L, 39 mg/L, 40 mg/L, 41 mg/L, 42 mg/L, 43 mg/L, 44 mg/L, 45 mg/L, 46 mg/L, 47 mg/L, 48 mg/L, 49 mg/L, 50 mg/L, or a value between two values thereof;
(3) Calcium carbonate alkali of 100˜300 mg/L, for example, 100 mg/L, 110 mg/L, 120 mg/L, 130 mg/L, 140 mg/L, 150 mg/L, 160 mg/L, 170 mg/L, 180 mg/L, 190 mg/L, 200 mg/L, 210 mg/L, 220 mg/L, 230 mg/L, 240 mg/L, 250 mg/L, 260 mg/L, 270 mg/L, 280 mg/L, 290 mg/L, 300 mg/L, or a value between two values thereof;
(4) Dissolved organic matter content of 5˜15mg/L, for example, 6 mg/L, 7 mg/L, 8 mg/L, 9 mg/L, 10 mg/L, 11 mg/L, 12 mg/L, 13 mg/L, 14 mg/L, 15 mg/L, or a value between two values thereof;
(5) Suspended matter content of 10˜50mg/L, for example, 10 mg/L, 15 mg/L, 20 mg/L, 25 mg/L, 30 mg/L, 35 mg/L, 40 mg/L, 45 mg/L, 50 mg/L, or a value between two values thereof;

According to an example, preparation of a gas containing ammonia by a liquid-gas separation membrane contactor 100 may be carried out in the process of treating domestic sewage containing ammoniacal nitrogen in public sewage treatment plants, private sewage treatment plants, etc., or in the process of treating industrial wastewater of semiconductor processes including high concentration ammonia nitrogen, or in the process of treating ammonia nitrogen in the effluent of an anaerobic microbial digestion tank that treats food and animal manure, but is not limited thereto.

### (b) Obtaining Ammonium Sulfate Crystals

At the step of (b), by supplying the gas containing ammonia to a mixed solution of an aqueous solution of sulfuric acid and a antisolvent of ammonium sulfate, ammonium sulfate crystals are obtained.

The gas containing ammonia is hydrated into ammonium ions (NH₄⁺) in a mixed solution of an aqueous solution of sulfuric acid and a antisolvent of ammonium sulfate, and simultaneously reacts with sulfate ions (SO₄²⁻) to form ammonium sulfate ((NH₄)₂SO₄) and may be immediately crystallized into the solid phase of ammonium sulfate by antisolvent of ammonium sulfate.

The antisolvent of ammonium sulfate may be selected from a group consisting of methanol, ethanol, 1,4-dioxane, dimethylformamide and acetone. In the present disclosure, the antisolvent is infinitely soluble in water (H₂O) at room temperature (miscible), but cannot dissolve ammonium sulfate, and forms hydrogen bonds with water molecules in the mixed solution, and thus there is not enough space for hydration of ammonium ions and sulfate ions in the mixed solution, so can be crystallized immediately as ammonium sulfate.

Volume ratio of the antisolvent of ammonium sulfate to the aqueous solution of sulfuric acid may be greater than 1. For example, it may be 1.1, 1.2, 1.3, 1.4, 1.5, 1.6, 1.7, 1.8, 1.9, 2.0, 2.1, 2.2, 2.3, 2.4, 2.5, 2.6, 2.7, 2.8, 2.9, 3.0, or a value between two values thereof, or a value above any one value thereof. As the input amount of the antisolvent of ammonium sulfate increases, the space in which sulfate ions and ammonium ions can be hydrated by water molecules decreases, and thus the crystallization efficiency of ammonium sulfate may increase.

The temperature of the mixed solution at step (b) may be 1030° C. For example, it may be 10° C., 15° C., 20° C., 25° C., 30° C., or a value between two values thereof. When the reaction temperature satisfies the above range, reaction energy efficiency can be maximized. The crystallization reaction of ammonium sulfate by the antisolvent of ammonium sulfate has low sensitivity to temperature and can be applied without any temperature adjustment process, and the ammonium sulfate crystals can be separated at lower temperatures compared to conventional evaporation processes, thereby reducing the energy used in crystallization of ammonium sulfate.

Since the ammonia recovery method of the present disclosure can maintain ammonium sulfate crystallization only by continuously supplying the gas containing ammonia and sulfuric acid aqueous solution, there is an advantage in that solid-phase ammonium sulfate crystals can be produced within a single step.

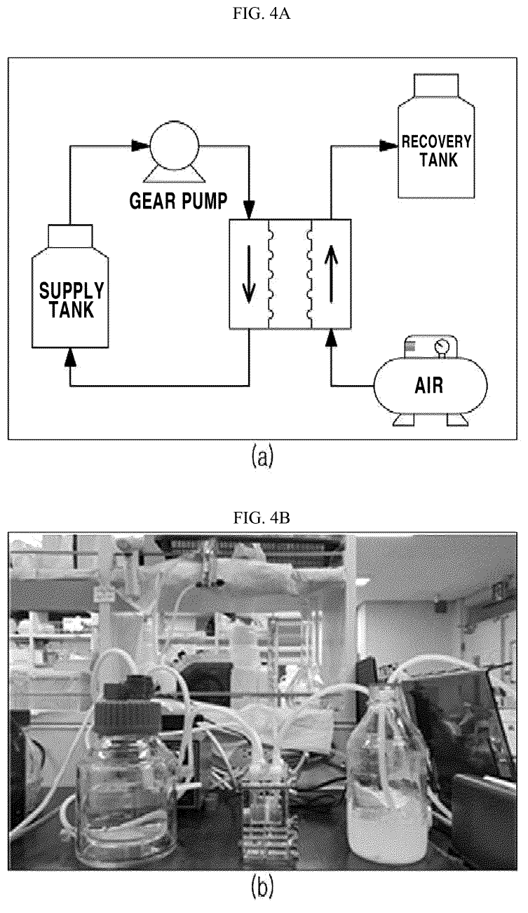

More specifically, in the present disclosure, since the antisolvent induces crystallization of ammonium sulfate and does not react, it can be used semi-permanently. For example, in the present disclosure, the antisolvent was found to have a crystallization efficiency of 80% or more even when reused about four times. That is, in the present disclosure, after the ammonium sulfate crystals are produced, without having to add additional antisolvent, by additionally adding concentrated sulfuric acid to the mixed solution in which crystals are formed (recovery tank part in FIG. 4A), ammonium sulfate crystals can be formed continuously. Therefore, in the case of injecting a high-concentration sulfuric acid aqueous solution, a sustainable ammonia separation system can be configured through antisolvent recycling.

### (c) Separating Ammonium Sulfate

At step (c), crystallized ammonium sulfate can be separated to obtain ammonium sulfate in the form of solid crystals.

Separation at step (c) may be performed through filtration, but is not limited thereto, and any method capable of separating the crystallized ammonium sulfate and the remaining solution may be applied without limitation. The crystallization method of ammonium sulfate according to the supply of ammonia-containing gas does not require evaporation or membrane separation, which consumes a lot of energy or takes a long time, and solid ammonium sulfate crystals can be obtained in a short time at a low temperature, and thus can be applied to various fields requiring crystallization of ammonium sulfate.

The ammonia recovery method described above, in conjunction with the ammonia recovery technology in the field of environmental engineering, enables immediate separation and purification of ammonium sulfate in the form of solid crystals as soon as supplying the ammonia recovered in gas phase to the mixed solution of the aqueous solution of sulfuric acid and the antisolvent of ammonium sulfate, thereby increasing the usability of recovered ammonia in the industry, and can be used as an alternative technology to evaporation, which is a conventional technology in the field of chemical engineering. Further, high-quality ammonium sulfate crystals separated by the ammonia recovery method described above can be used in fields such as agriculture and chemical industry.

Hereinafter, embodiments of the present specification will be described in more detail. However, the following experimental results describe only representative experimental results among the above embodiments, and the scope and contents of the present specification cannot be reduced or limited by the embodiments. Each effect of the various embodiments of the present specification that is not explicitly presented below is to be specifically described in the corresponding section.

### Evaluation of Crystallization Efficiency of Ammonium Sulfate

After supplying 5 mL of 1 M sulfuric acid solution to a 50 mL conical tube made of polypropylene, 5 mL, 10 mL, 15 mL, 20 mL, 25 mL, 30 mL, 35 mL, 40 mL, and 45 mL of ethanol (i.e., one of antisolvents) were supplied, respectively, to prepare a sulfuric acid aqueous solution-antisolvent mixture. By additionally supplying 5 mL of 2M ammonia water (Ammonium Hydroxide, NH₄OH) to each conical tube, the antisolvent to aqueous solution ratio (N/A ratio) was adjusted to 0.5, 1, 1.5, 2, 2.5, 3, 3.5, 4, and 4.5, and were sequentially set to Comparative Examples 1 and 2, and Examples 1 to 7.

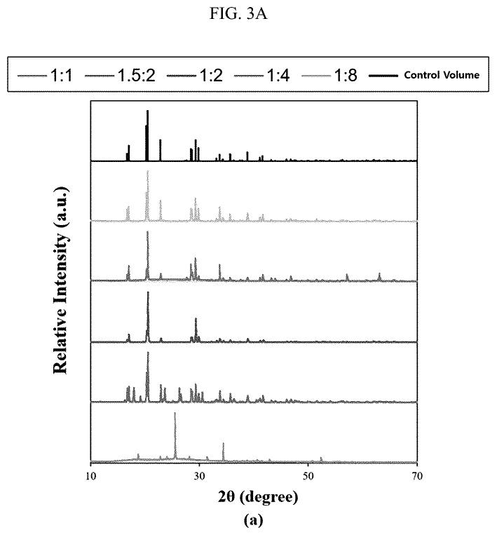

Thereafter, after stirring at a speed of 60 rpm for 10 minutes at a temperature of 20° C. utilizing a horizontal stirrer, ammonium sulfate crystals were separated using a 0.45 μm filter and dried overnight. The separated ammonium sulfate was weighed and the crystallization efficiency of the ammonium sulfate was calculated using equation 1 below, and a graph of the result of the crystallization efficiency is shown in FIG. 2. The crystallization efficiency refers to the ratio of the weight of separated ammonium sulfate crystals after drying and weight of dissolved ammonium sulfate before reaction.

$$Crystallization efficiency ( \% ) = \frac{Weight of dried crystals after separation}{\begin{matrix}Weight of dissolved ammonium \\ sulfate before reaction\end{matrix}} \times 100 \qquad [ Equation 1 ]$$

Referring to FIG. 2, it can be seen that ammonium sulfate can be obtained in the form of crystals by supplying ammonia to the mixed solution of aqueous solution of sulfuric acid-antisolvent. It can be seen that crystallization of ammonium sulfate is performed when the volume ratio (N/A ratio) of the antisolvent to the aqueous sulfuric acid solution is 1.5 or more, and that the crystallization efficiency of ammonium sulfate improves as the supply amount of antisolvent increases. Particularly, when the volume ratio of the antisolvent-aqueous solution is 3 or more, it can be seen that the crystallization efficiency of ammonium sulfate has a very high value of 80% or more.

### Quality Evaluation of Ammonium Sulfate According to the Sulfate-Ammonia Ratio

In the conventional evaporative crystallization method and the antisolvent crystallization method according to the present disclosure, the quality of ammonium sulfate was evaluated according to the sulfuric acid-ammonia ratio. For quality evaluation, sulfuric acid-ammonia mixed solutions having different molar ratios of sulfuric acid-ammonia were prepared as shown in Table 1 below. 1M sulfuric acid solution was used as the sulfuric acid solution, and 2M aqueous ammonia solution was used as the ammonia water.

TABLE 1

| Molar ratio of sulfuric | | | | |
|---|---|---|---|---|
| acid to ammonia | Sulfuric acid solution | | Ammonia water | |
| 1:8 | 2 | mL | 8 | mL |
| 1:4 | 3.33 | mL | 6.67 | mL |
| 1:2 | 5 | mL | 5 | mL |
| 1.5:2 | 6 | mL | 4 | mL |
| 1:1 | 6.67 | mL | 3 | mL |

As an antisolvent of ammonium sulfate, 40 mL of ethanol was supplied to each conical tube. Next, after stirring for 10 minutes at a speed of 60rpm at a temperature of 20° C. utilizing a horizontal stirrer, ammonium sulfate crystals were separated using a 0.45 μm filter and dried overnight. Further, in the same manner, sulfate-ammonia mixed solutions having different molar ratios of sulfate-ammonia were prepared, and ammonium sulfate in crystal form was separated by a conventional evaporation crystallization method.

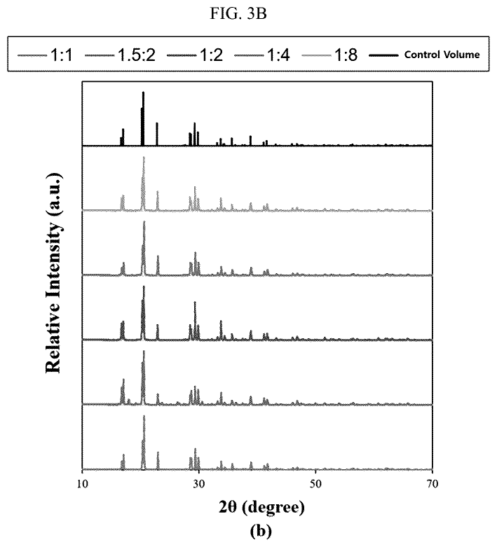

The crystal structures of ammonium sulfate separated by the antisolvent crystallization method according to the present disclosure and ammonium sulfate separated by the conventional evaporative crystallization method were analyzed using x-ray diffraction metric (XRD), and the quality of each ammonium sulfate crystal was analyzed using the GR grade ammonium sulfate product as a control. The result is shown in FIGS. 3A and 3B.

FIG. 3A shows the result of XRD analysis of ammonium sulfate crystals obtained by the conventional evaporative crystallization method. Referring to FIG. 3B, the ammonium sulfate obtained by the conventional evaporative crystallization method exhibits XRD peaks different from those of the control group at the sulfuric acid-ammonia molar ratio of 1.5:2 and 1:1, where the sulfuric acid ratio increases, confirming that when the proportion of sulfuric acid increases, crystals other than ammonium sulfate or crystals containing impurities are formed.

FIG. 3B shows the result of XRD analysis of ammonium sulfate crystals obtained by the antisolvent crystallization method of the present disclosure. Referring to FIG. 3B, the ammonium sulfate obtained by this method shows the same XRD peaks as the control group at all ratios, and it can be confirmed that is has 10 representative peaks of ammonium sulfate crystals (2θ°, 17.0°, 20.2°, 20.5°, 22.8°, 28.4°, 28.6°, 29.2°, 29.8°, 33.7°). This means that, according to the antisolvent crystallization method of the present disclosure, highly pure ammonium sulfate crystals can be obtained regardless of the molar ratio of sulfate to ammonia.

### EXAMPLES 1 TO 3

Ammonium sulfate crystallization was performed using the apparatus shown in FIGS. 4A and 4B. FIG. 4A is a schematic conceptual diagram used in the embodiment, and FIG. 4B is a photographed image of the actual module.

First, 500 mL of 1M ammonia solution made of ammonium chloride was added to a feed tank, and 50 mL of 0.5M sulfuric acid solution and 200 mL of ethanol were added to a strip tank.

Thereafter, 1M ammonia solution was supplied to the first region of the liquid-gas separation membrane contactor at a rate of 400 mL/min using a gear pump, and air was supplied to the second region of the liquid-gas separation membrane contactor at a rate of 500 mL/min using an air pump.

As the hydrophobic gas permeable membrane, a GVHD-14250 PVDF hydrophobic membrane from Millepore, having a pore size of 0.22 μm, a porosity of 75%, and a thickness of 125 μm, was used, and the temperature of the strip tank was kept constant at 20° C.

After performing the experiment for 4 hours, the crystals formed in a recovery tank were filtered through a 0.45 μm filter and dried to obtain ammonium sulfate, and the experiment was repeated 3 times to obtain the ammonium sulfate of Examples 1, 2, and 3.

### EXPERIMENTAL EXAMPLE 1: FT-IR ANALYSIS EVALUATION

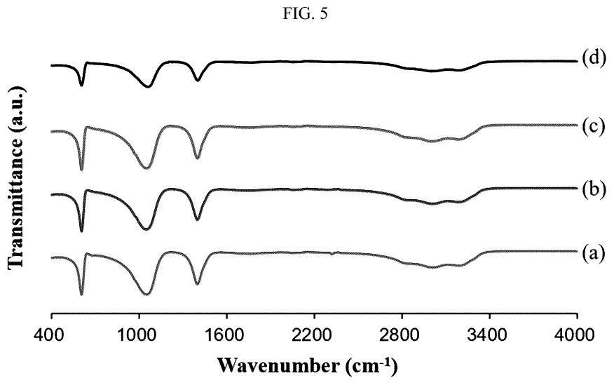

FT-IR analysis was performed on the ammonium sulfate obtained in Examples 1 to 3 and the ammonium sulfate first class reagent as a control, and the results are shown in FIG. 5.

(a) to (c) of FIG. 5 are FT-IR analysis results of ammonium sulfate obtained in Examples 1 to 3, respectively, and (d) of FIG. 5 is FT-IR analysis result for ammonium sulfate first class reagent.

Referring to FIG. 5, it can be seen that the ammonium sulfate of Examples 1 to 3 and the GR grade ammonium sulfate product as a control show similar FT-IR patterns. From this, it can be confirmed that the ammonium sulfate of Examples 1 to 3 has a quality similar to that of the control group.

### EXPERIMENTAL EXAMPLE 2: ELEMENTAL ANALYSIS EVALUATION

Elemental analysis was performed on the ammonium sulfate according to Examples 1 to 3 and the ammonium sulfate first class reagent as a control using elemental analysis (EA), and the results are shown in Table 2 below. (Average±standard deviation, 3 times repeated experiments)

TABLE 2

| | C | H | N | O | S |
|---|---|---|---|---|---|
| | (Atomic %) | (Atomic %) | (Atomic %) | (Atomic %) | (Atomic %) |
| Example 1 | 0.207 | 6.240 | 22.763 | 45.513 | 25.373 |
| Example 2 | 0.329 | 6.211 | 22.890 | 45.720 | 25.418 |
| Example 3 | 0.224 | 6.254 | 22.955 | 45.086 | 25.421 |
| Average of | 0.253 ± 0.066 | 6.235 ± 0.022 | 22.869 ± 0.098 | 45.440 ± 0.323 | 25.404 ± 0.027 |
| Examples 1 to 3 ± | | | | | |
| Standard Deviation | | | | | |
| Control Group | 0.178 | 6.229 | 22.678 | 45.823 | 25.464 |

Referring to Table 2, it can be seen that the ratio of elements constituting the ammonium sulfate of Examples 1 to 2 and the ratio of elements in the control group are similar. From this, it can be confirmed that the ammonium sulfate of Examples 1 and 2 has a quality similar to that of the control group. The above description of this specification is for illustrative purposes, and those skilled in the art that one aspect of the present specification belongs to will understand that it can be easily transformed into other specific forms without changing the technical idea or essential features described in this specification. Therefore, it should be understood that the embodiments described above are illustrative in all respects and not limiting. For example, each component described as a single type may be implemented in a distributed manner, and similarly, components described as distributed may be implemented in a combined form.

The scope of the present specification is indicated by the following claims, and all changes or modifications derived from the meaning and scope of the claims and equivalent concepts thereof should be construed as being included in the scope of the present specification.

What is claimed is:

1. A method for recovering ammonia, comprising:
(a) preparing a gas containing ammonia;
(b) supplying the gas containing ammonia to a mixed solution of an aqueous solution of sulfuric acid and a antisolvent of ammonium sulfate, to obtain ammonium sulfate crystals; and
(c) separating the ammonium sulfate crystals from the mixed solution,
wherein a volume ratio of the antisolvent of ammonium sulfate to the aqueous solution of sulfuric acid is greater than 1.

2. The method for recovering ammonia, according to claim 1,
wherein the volume ratio of the antisolvent of ammonium sulfate to the aqueous solution of sulfuric acid is 1.5 or more.

3. The method for recovering ammonia, according to claim 1,
wherein the volume ratio of the antisolvent of ammonium sulfate to the aqueous solution of sulfuric acid is 3 or more.

4. The method for recovering ammonia, according to claim 1,
wherein the antisolvent of ammonium sulfate is selected from a group consisting of methanol, ethanol, 1,4-dioxane, dimethylformamide and acetone.

5. The method for recovering ammonia, according to claim 1,
wherein temperature of the mixed solution at step (b) is 10˜30° C.

6. The method for recovering ammonia, according to claim 1,
wherein the separating at step (c) is performed through filtering.

7. The method for recovering ammonia, according to claim 1,
wherein the preparing of a gas containing ammonia is performed by a hydrophobic gas permeable membrane and a liquid-gas separation membrane contactor including a first region and a second region separated by the hydrophobic gas permeable membrane, and step (a) comprises:
(a1) supplying treated water including ammonia to the first region and supplying an ammonia nonreactive gas to the second region; and
(a2) recovering the gas containing ammonia from the second region.

8. The method for recovering ammonia, according to claim 7,
wherein flow direction of the treated water of the first region and flow direction of the ammonia nonreactive gas of the second region are opposite to each other.

9. The method for recovering ammonia, according to claim 7,
wherein a pore of the hydrophobic gas permeable membrane does not transmit liquid phase matter.

10. The method for recovering ammonia, according to claim 7,
wherein the hydrophobic gas permeable membrane satisfies at least one of conditions (i) to (iv) below:
(i) thickness of 10˜200 μm;
(ii) average pore size of 0.01˜0.50 μm;
(iii) porosity of 30˜85%; and
(iv) hydrophobic substance.

11. The method for recovering ammonia, according to claim 7,
wherein the treated water including ammonia is sewage, and the hydrophobic gas permeable membrane satisfying at least one of the conditions (1) to (5) below is used:
(1) pH 6.0˜8.0;
(2) nitrogen content is 25˜50mg/L;
(3) calcium carbonate alkali is 100˜300mg/L;
(4) dissolved organic matter content is 5˜15mg/L; and
(5) suspended matter content is 10˜50mg/L.
